(19) United States
(12) Patent Application Publication
(10) Pub. No.: US 2023/0247035 A1
(43) Pub. Date: Aug. 3, 2023

(54) ATTACK DETECTION APPARATUS, ATTACK DETECTION METHOD AND PROGRAM

(71) Applicant: NIPPON TELEGRAPH AND TELEPHONE CORPORATION, Tokyo (JP)

(72) Inventors: Masaru MATSUBAYASHI, Tokyo (JP); Takuma KOYAMA, Tokyo (JP); Yasushi OKANO, Tokyo (JP); Masashi TANAKA, Tokyo (JP)

(73) Assignee: NIPPON TELEGRAPH AND TELEPHONE CORPORATION, Tokyo (JP)

(21) Appl. No.: 17/923,192

(22) PCT Filed: May 12, 2020
(86) PCT No.: PCT/JP2020/019011

§ 371 Date: Nov. 3, 2022

(51) Int. Cl. H04L 9/40

(52) U.S. Cl. CPC H04L 63/1425

(57) ABSTRACT

An attack detection apparatus that detects an attack on a network within equipment, improves detection accuracy of an attack on the network within the equipment by including a processor and a memory storing program instructions that cause the processor to extract a set of two messages that have the same payload from a plurality of messages transmitted in a certain period, and determine whether or not the attack is made on the basis of whether or not another message is transmitted between transmissions of the two messages of the set and an interval of transmission of the two messages.

### TECHNICAL FIELD

The present invention relates to an attack detection apparatus, an attack detection method, and a program.

### BACKGROUND ART

Among IoT equipment, there is equipment on which a plurality of electronic control devices are mounted. For example, an electronic control unit (ECU) is mounted on an automobile as an electronic control device. Hereinafter, the electronic control device will be referred to as an “ECU” for the purpose of convenience regardless of types of IoT equipment.

A plurality of ECUs are connected to a bus network (hereinafter, referred to as a “CAN bus”) and function by broadcasting messages that comply with controller area network (CAN) protocol to the CAN bus to perform communication with each other.

In a message to be transmitted/received in CAN communication (hereinafter, referred to as a “communication message”), a payload which is a data body to be transmitted and an ID (hereinafter, referred to as a “CAN-ID”) to be used for identifying content of the payload are stored.

Information regarding a transmission source is not included in the communication message, and thus, an illegal message can be easily transmitted to (inserted into) the CAN bus by impersonation. For example, it is known that control of an automobile is taken over by insertion of an illegal message. Thus, a technique of detecting an illegal communication message inserted into the CAN bus is important.

Most of communication messages relating to functions of control, or the like, of an automobile are designed to be periodically transmitted with a transmission period for each CAN-ID as illustrated in FIG. 1. In a case where an insertion attack of an illegal communication message occurs, as illustrated in FIG. 2, messages are transmitted at an interval shorter than the transmission period. In related art, there has been a rule-based attack detection technique utilizing this feature (for example, Non-Patent Literature 1).

### CITATION LIST

### Non-Patent Literature

Non-Patent Literature 1: Satoshi Otsuka, Tasuku Ishigooka, “Intrusion Detection for In-vehicle Networks without Modifying Legacy ECUs”, IPSJ SIG Technical Report, Vol. 2013-SLDM-160, No. 6, pp. 1-5, (2013)

### SUMMARY OF THE INVENTION

### Technical Problem

While most messages of CAN-IDs relating to control, or the like, of an automobile are periodically transmitted for each CAN-ID, there exists communication in which message transmission that coordinates with an event such as operation of a driver and periodical message transmission are mixed (hereinafter, referred to as “periodic+event type communication”). In related art, “periodic+event type communication” is not taken into account, and thus, there is a possibility that normal communication may be erroneously detected as an attack.

The present invention has been made in view of the above-described point and is directed to improving detection accuracy of an attack on a network within equipment.

### Means for Solving the Problem

Thus, to solve the above-described problem, an attack detection apparatus that detects an attack on a network within equipment includes an extraction unit configured to extract a set of two messages having the same payload from a plurality of messages transmitted in a certain period, and a determination unit configured to determine whether or not the attack is made on the basis of whether or not another message is transmitted between transmissions of the two messages of the set and an interval of transmission of the two messages.

### Effects of the Invention

It is possible to improve detection accuracy of an attack on a network within equipment.

### BRIEF DESCRIPTION OF DRAWINGS

FIG. 1 is view for explaining periodicity of communication messages.

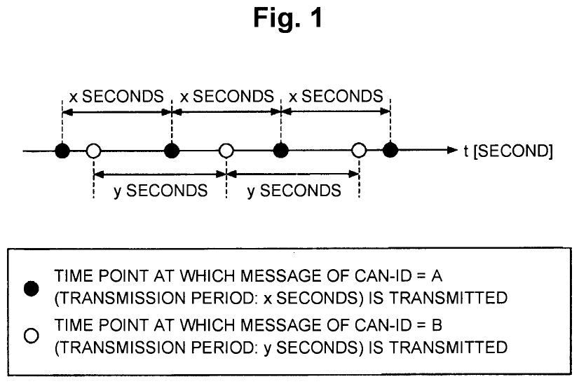

FIG. 2 is view for explaining a detection method of an insertion attack of an illegal communication message in related art.

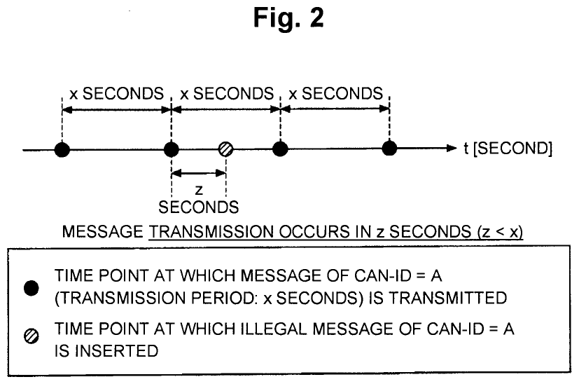

FIG. 3 is a view illustrating a configuration example of a communication system 1 in a first embodiment.

FIG. 4 is a view illustrating a hardware configuration example of a communication information processing device 10 in the first embodiment.

FIG. 5 is a view for explaining Type-A.

FIG. 6 is a view for explaining Type-B.

FIG. 7 is a view for explaining erroneous detection of an attack in Type-A.

FIG. 8 is a view for explaining a reason why an attack on Type-A can be detected using a rule A1.

FIG. 9 is a view for explaining a reason why an attack on Type-A can be detected using a rule A2.

FIG. 10 is a view for explaining a reason why an attack on Type-B can be detected.

FIG. 11 is a view illustrating a functional configuration example of the communication system 1 in the first embodiment.

FIG. 12 is a flowchart for explaining an example of processing procedure to be executed by the communication information processing device 10.

FIG. 13 is a view for supplementing explanation of processing procedure relating to Type-A.

FIG. 14 is a view for supplementing explanation of processing procedure relating to Type-B.

FIG. 15 is a view illustrating a functional configuration example of the communication system 1 in a second embodiment.

FIG. 16 is a view illustrating a functional configuration example of the communication system 1 in a third embodiment.

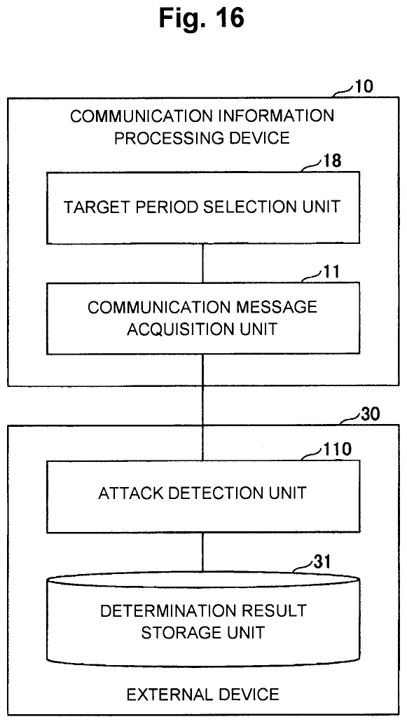

### DESCRIPTION OF EMBODIMENTS

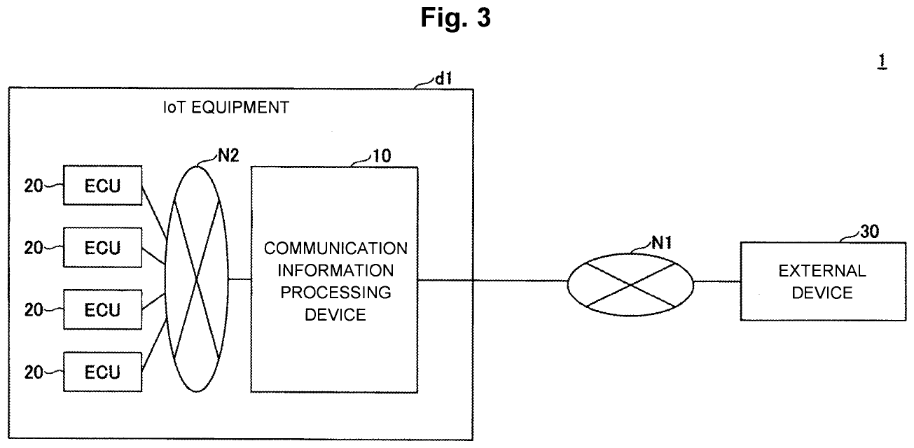

Embodiments of the present invention will be described below on the basis of the drawings. FIG. 3 is a view illustrating a configuration example of a communication system 1 in a first embodiment. In FIG. 3, equipment d1 is connected to an external device 30 via an external network N1 such as the Internet. The external network N1 may include a wireless communication network such as a mobile communication network.

The equipment d1 is Internet of things (IoT) equipment typified by a mobile body such as an automobile, a train, an airplane, a ship and a drone, an agricultural sensor network, or the like. In the present embodiment, while an example will be assumed where the equipment d1 is an automobile, the present embodiment may be applied to other types of IoT equipment.

In FIG. 3, the equipment d1 includes hardware such as a plurality of ECUs 20, a CAN bus N2 and a communication information processing device 10.

The ECU 20 is an example of an electronic control device that electronically controls various kinds of functions/mechanisms of the equipment d1. Each ECU 20 transmits/receives messages (hereinafter, referred to as “communication messages”) to/from each other through controller area network (CAN) communication via a bus network within equipment (hereinafter, referred to as the “CAN bus N2”). In the present embodiment, description will be provided assuming CAN communication. However, the present embodiment can be applied to other types of communication protocol and networks within equipment having communication characteristics such as a characteristic that a communication interval of each of communications classified with header information, or the like, (in a case of CAN communication, CAN-IDs) has periodicity, and a characteristic that the periodicity changes in accordance with change of a specific value of a payload. Note that the present embodiment takes into account communication in which message transmission that coordinates with an event such as operation by an operator (such as a driver if the equipment d1 is an automobile) of the equipment d1 is mixed in addition to periodic communication messages (hereinafter, referred to as “periodic+event type communication”). Hereinafter, among the communication messages, a message to be periodically transmitted will be referred to as a “periodic message”, and a message to be transmitted in accordance with an event that occurs asynchronously with a period of the periodic message will be referred to as an “event message”.

The communication information processing device 10 is a device (computer) that determines whether or not there is an attack on the CAN bus N2 by monitoring communication messages in the CAN bus N2 and transmits a determination result to the external device 30.

The external device 30 is one or more computers that store the determination result by the communication information processing device 10.

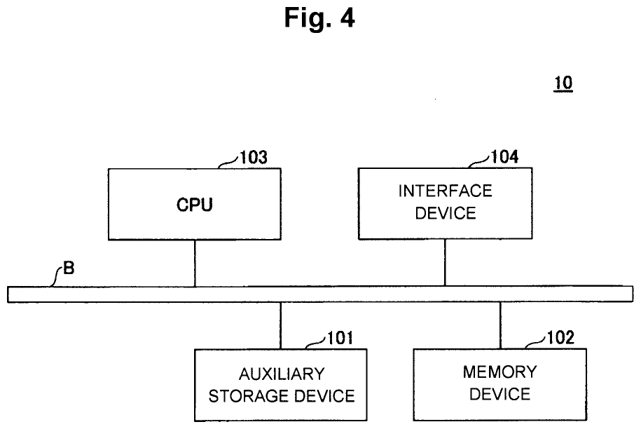

FIG. 4 is a view illustrating a hardware configuration example of the communication information processing device 10 in the first embodiment. The communication information processing device 10 in FIG. 4 includes an auxiliary storage device 101, a memory device 102, a CPU 103, an interface device 104, and the like, that are connected to one another with a bus B.

A program that implements processing at the communication information processing device 10 is installed at the auxiliary storage device 101. The auxiliary storage device 101 stores the installed program and stores necessary files, data, and the like.

The memory device 102 reads out and stores the program from the auxiliary storage device 101 in a case where an instruction to start the program is issued. The CPU 103 executes functions relating to the communication information processing device 10 in accordance with the program stored in the memory device 102. The interface device 104 is used as an interface for connecting to the CAN bus N2 and the external network N1.

Note that the external device 30 may also have a similar hardware configuration.

The periodic+event type communication in the present embodiment will be described. In the present embodiment, a type (Type) of the periodic+event type communication is classified into Type-A and Type-B.

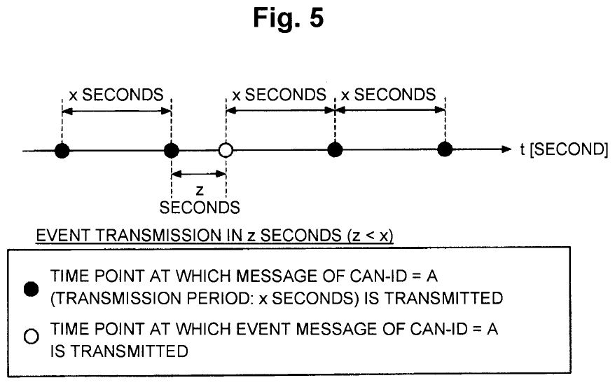

FIG. 5 is a view for explaining Type-A. As illustrated in FIG. 5, Type-A is a type in which a transmission interval between an event message and a periodic message immediately after the event message is a transmission period corresponding to a CAN-ID of the periodic message.

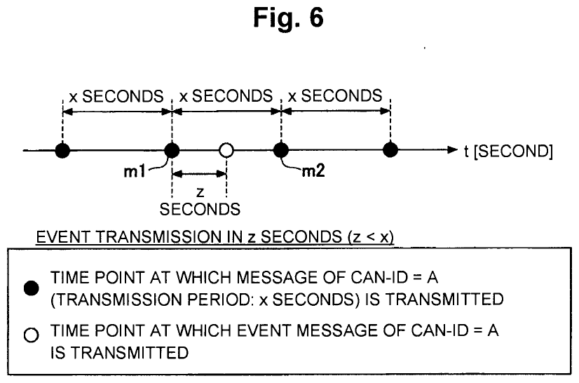

FIG. 6 is a view for explaining Type-B. As illustrated in FIG. 6, Type-B is a type in which a transmission interval of periodic messages becomes the transmission period regardless of whether or not there is an event message (that is, a type in which the event message does not affect the transmission period of periodic messages).

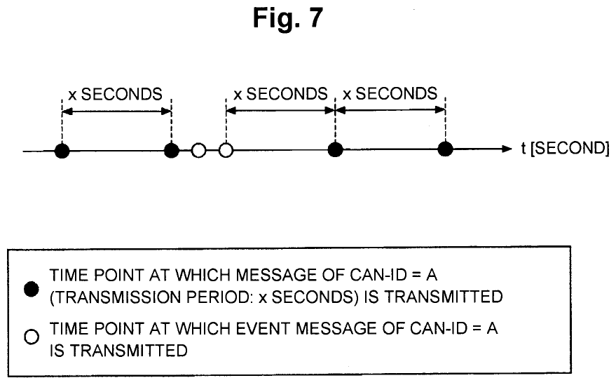

Note that in a case where messages of Type-A are monitored using the technique in Non-Patent Literature 1, if β<z, a possibility of erroneous detection is low. However, in a case where β≥z or in a case where event messages are successively transmitted twice as in FIG. 7, occurrence of an attack is erroneously detected.

On the other hand, in a case where messages of Type-B are monitored using the technique in Non-Patent Literature 1, if an interval of a communication message m1 and a communication message m2 in FIG. 6 is within a transmission period+β, all event messages occurring during that interval are erroneously detected as attacks.

Thus, in the present embodiment, an attack is detected using a method (hereinafter, referred to as a “detection method”) appropriate for each Type.

A detection method of an attack on Type-A will be described. Outline of procedure of the detection method for Type-A is as follows.

(1) Extract all sets of two messages having the same payload from communication messages in a certain period as target messages
(2) Extract the following two feature amounts a1 and a2 from the two messages of each of the extracted sets

(a1) a feature amount indicating whether the two messages have a non-adjacency relationship or an adjacency relationship (“non-adjacency relationship”/“adjacency relationship”) (hereinafter, referred to as the “feature amount a1”)

(a2) a feature amount indicating whether or not an interval (transmission interval) of transmission time points of the two messages is similar to the transmission period (“similarity”/“dissimilarity”) (hereinafter, referred to as the “feature amount a2”)

Note that concerning the feature amount a1, the adjacency relationship refers to a relationship in which there is no other message for which a transmission time point (transmission timing) is included between the transmission time points (transmission timings) of the two messages. Meanwhile, the non-adjacency relationship refers to a relationship in which there are other messages for which transmission time points are included between the transmission time points of the two messages.

(3) Determine that an attack occurs (detect occurrence of an attack) in a case where the extracted two feature amounts correspond to one or both of the following rules A1 and A2

Rule A1: feature amount a1=“adjacency relationship” and feature amount a2=“dissimilarity”

Rule A2: feature amount a1=“non-adjacency relationship” and feature amount a2=“similarity”

Reasons why an attack on Type-A can be detected using the above rules A1 and A2 will be described.

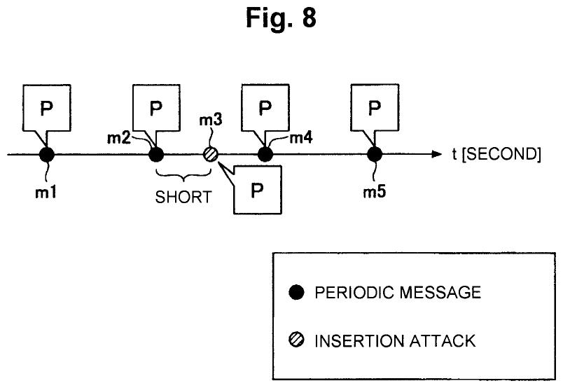

FIG. 8 is a view for explaining a reason why an attack on Type-A can be detected using the rule A1. Note that in FIG. 8, a character “P” in a balloon provided to each of the communication messages m1 to m5 indicates a value of a payload. In other words, communication messages for which the characters are the same have an identical payload. Thus, payloads of the communication messages m1 to m5 in FIG. 8 are identical.

The ECU 20 does not transmit an event message that has the same payload as a payload of the periodic message (hereinafter, referred to as an “event message with no change in payload”) for communication messages having the same CAN-ID in a normal state (in a state where there is no attack). In other words, in a normal state (in a state where there is no attack), a state as illustrated in FIG. 8 (a state corresponding to the rule A1) does not occur. According to the rule A1, it is possible to detect an event message with no change in payload. It is therefore possible to detect that a message detected by the rule A1 is not a normal event message but an insertion attack such as a replay attack.

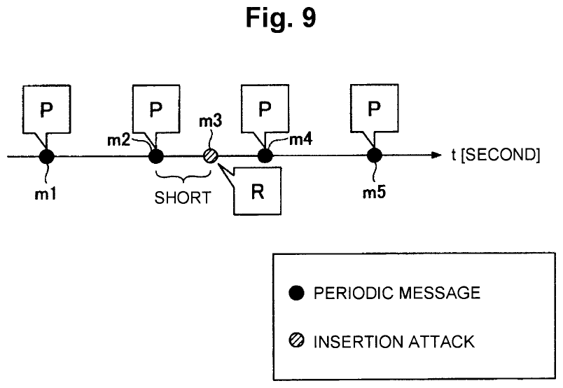

FIG. 9 is a view for explaining a reason why an attack on Type-A can be detected using the rule A2. Meaning of the balloon in FIG. 9 is the same as that in FIG. 8. Thus, in FIG. 9, a payload “R” of the communication message m3 is different from payloads “P” of other communication messages.

A transmission period and payloads of communication messages to be transmitted by the ECU 20 do not change by being affected by an insertion attack (insertion of a communication message aimed at an attack). In other words, payloads of communication messages before and after the insertion attack become always equal and the transmission interval of the communication messages becomes equal to a periodic interval. According to the rule A2, such a state can be detected, so that it is possible to detect an attack.

Note that while in the present embodiment, an example where two rules are employed for Type-A, one of the rule A1 and the rule A2 may be employed.

A detection method of an attack on Type-B will be described next. Outline of procedure of the detection method for Type-B is as follows.

(1) Extract two or more communication messages including payloads that are identical with payloads of the immediately preceding communication messages as target messages
(2) Extract the following feature amount b from the extracted communication messages

(b) a feature amount

(“similarity”/“dissimilarity”) indicating whether or not an interval (transmission interval) of transmission time points between the extracted communication messages is similar to the transmission period
(3) Determine as an attack in a case where the feature amount b corresponds to the following rule B

Rule B: feature amount b=“dissimilarity”

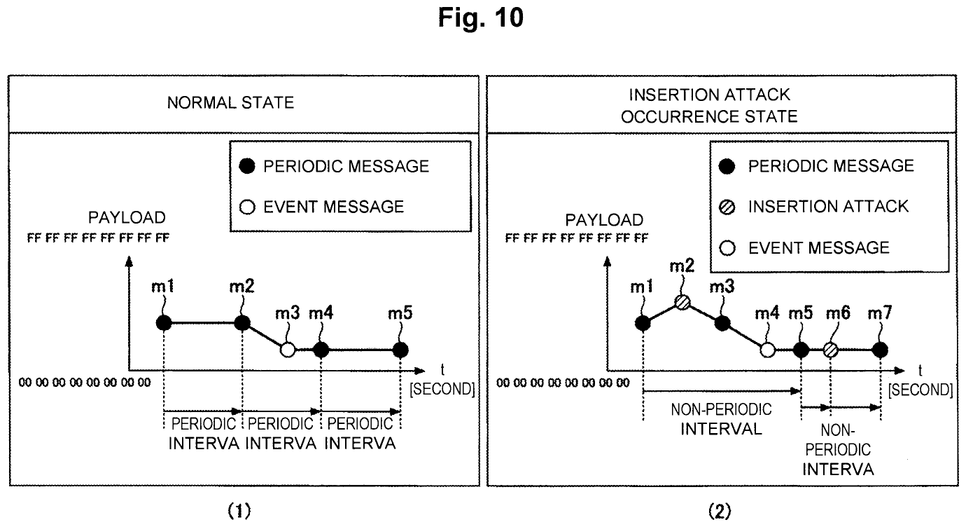

A reason why an attack on Type-B can be detected using the rule B will be described. FIG. 10 is a view for explaining a reason why an attack on Type-B can be detected.

In a normal state of Type-B, as illustrated in (1) of FIG. 10, a “communication message including a payload identical with a payload of the immediately preceding communication message” is always transmitted at a periodic interval regardless of whether or not there is an event message. Note that while a communication message immediately preceding the communication message m1 is not illustrated in (1) of FIG. 10, it is assumed that the communication message m1 is a communication message including a payload identical with a payload of the immediately preceding communication message which is not illustrated. Thus, in (1) of FIG. 10, the communication messages m1, m2, m4 and m5 correspond to communication messages including payloads identical with the payloads of the immediately preceding communication messages, and a transmission interval of these is periodic.

Meanwhile, in a case where an insertion attack is made, as illustrated in (2) of FIG. 10, “communication messages including payloads identical with the payloads of the immediately preceding communication messages” do not always appear at a periodic interval. Note that in (2) of FIG. 10, the communication message m1 is a communication message including a payload identical with the payload of the immediately preceding communication message which is not illustrated in a similar manner to (1). Thus, in (2) of FIG. 10, while the communication messages m1, m5, m6 and m7 correspond to communication messages including payloads identical with the payloads of the immediately preceding communication messages, a transmission interval of these communication messages is aperiodic (is not the original period). The rule for Type-B is a rule of detecting that “communication messages including payloads identical with the payloads of the immediately preceding communication messages” do not appear at a periodic interval, and thus, an insertion attack can be detected.

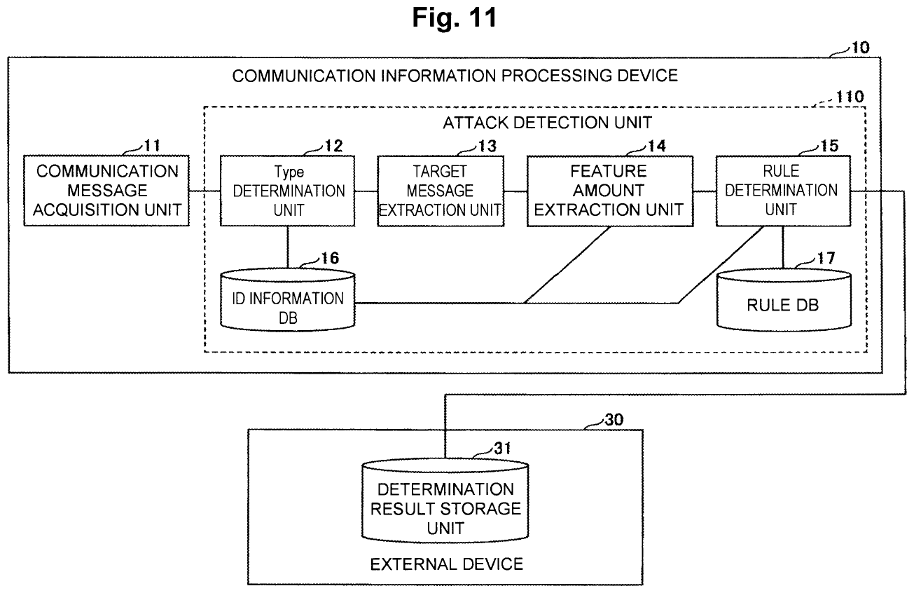

To implement attack detection as described above, the communication system 1 has a functional configuration as illustrated in FIG. 11. FIG. 11 is a view illustrating a functional configuration example of the communication system 1 in the first embodiment. A case will be described below where (a communication message relating to) one CAN-ID is to be monitored (hereinafter, referred to as a “target ID”). In a case where there are a plurality of CAN-IDs to be monitored, it is only necessary that processing in the following description is performed for each CAN-ID.

In FIG. 11, the communication information processing device 10 includes a communication message acquisition unit 11, a Type determination unit 12, a target message extraction unit 13, a feature amount extraction unit 14, a rule determination unit 15, and the like. These are implemented by one or more programs installed at the communication information processing device 10 causing the CPU 103 to execute processing. The communication information processing device 10 also utilizes databases (storage units) such as an ID information DB 16 and a rule DB 17. These databases (storage units) can be implemented using, for example, the auxiliary storage device 101, or the like.

Note that the Type determination unit 12, the target message extraction unit 13, the feature amount extraction unit 14, the rule determination unit 15, the ID information DB 16 and the rule DB 17 constitute the attack detection unit 110.

Meanwhile, the external device 30 includes a determination result storage unit 31. The determination result storage unit 31 can be implemented using an auxiliary storage device, or the like, provided at the external device 30.

The communication message acquisition unit 11 acquires a “payload” and a “transmission time point” of each communication message including a target ID occurring in a certain period (hereinafter, referred to as a “target period”). However, the communication message acquisition unit 11 may additionally acquire values of other fields such as a CAN-ID and a data length code (DLC). Note that the “transmission time point” is a time point (timing) at which the communication message acquisition unit 11 acquires the communication message. A value of the “transmission time point” may be an absolute time point or a relative time point (elapsed period) from some kinds of reference time points. Further, while the target period is preferably a period equal to or longer than twice the transmission period set for the target ID in the ID information DB 16, the target period may be equal to or shorter than the transmission period. Further, the communication message acquisition unit 11 may acquire all the communication messages or, in a case where some kinds of conditions are satisfied (for example, in a case where another abnormality detection mechanism detects an abnormality), may acquire a communication message relating to the abnormality.

In the ID information DB 16, a transmission period, a margin β and Type set in advance for each CAN-ID are stored in association with each CAN-ID. However, information stored in the ID information DB 16 does not have to be limited to these.

The Type determination unit 12 determines Type corresponding to the target ID with reference to the information stored in the ID information DB 16.

The target message extraction unit 13 extracts a target message in accordance with Type.

The feature amount extraction unit 14 acquires the transmission period, the margin β and Type of the target ID from the ID information DB 16 and extracts a feature amount (the feature amounts a1 and a2 or the feature amount b which will be described later) in accordance with the Type from the target message extracted by the target message extraction unit 13 on the basis of these kinds of information. However, the feature amount extraction unit 14 may additionally extract feature amounts other than the feature amounts a1 and a2 or the feature amount b.

In the rule DB 17, rules (the rules A1 and A2 and the rule B described above) defined in advance are stored for each Type. The rule refers to a rule for detecting an attack. However, a rule (hereinafter, referred to as a “rule C”) other than the rules A1 and A2 and the rule B may be stored in the rule DB 17.

The rule determination unit 15 acquires Type corresponding to the target ID from the ID information DB 16 and acquires a rule corresponding to the Type from the rule DB 17. The rule determination unit 15 determines whether or not the feature amount extracted by the feature amount extraction unit 14 corresponds (matches) the rule to determine whether or not there is an attack (detect an attack). The rule determination unit 15 records (transmits) the determination result in (to) the determination result storage unit 31.

Note that the information or the rule may be acquired from the ID information DB 16 and the rule DB 17 once at the beginning or may be acquired every time determination is performed. Further, in a case where the rule C is stored in the rule DB 17, the rule determination unit 15 may determine whether or not there is an attack also using the rule C.

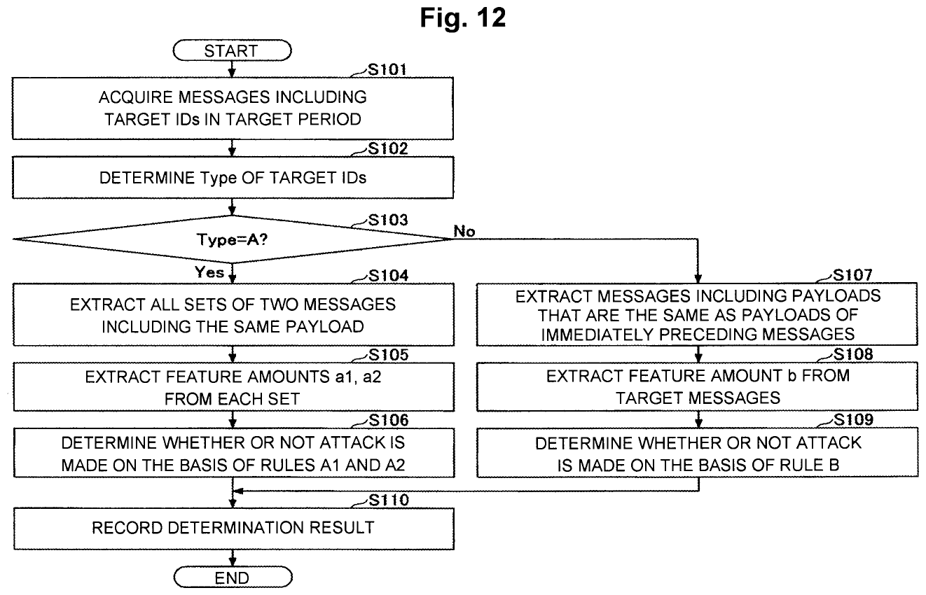

Processing procedure to be executed by the communication information processing device 10 will be described below. FIG. 12 is a flowchart for explaining an example of the processing procedure to be executed by the communication information processing device 10.

The communication message acquisition unit 11 acquires a “payload” and a “transmission time point” of each of a plurality of communication messages including a target ID among communication messages to be transmitted to the CAN bus' N2 during the target period (S101). Subsequently, the Type determination unit 12 acquires Type corresponding to the target ID from the ID information DB 16 and determines whether the Type is “Type-A” or “B” (S102).

In a case where the Type corresponding to the target ID is “Type-A” (S103: Yes), the target message extraction unit 13 extracts each of all sets of two messages including the same payload from a plurality of communication messages acquired by the communication message acquisition unit 11 as target messages (S104).

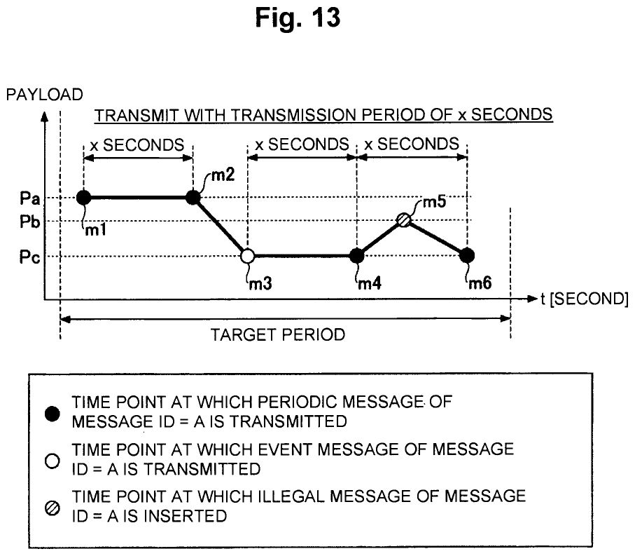

FIG. 13 is a view for supplementing explanation of processing procedure relating to Type-A. FIG. 13 illustrates an example where communication messages of {m1, m2, m3, m4, m5, m6} are acquired in step S101. FIG. 13 indicates time on a horizontal axis and indicates a payload on a vertical axis. In other words, in step S104, sets of communication messages having the same value on the vertical axis are extracted. For example, each of four sets of {m1, m2}, {m3, m4}, {m3, m6} and {m4, m6} is extracted as target messages. Specifically, payloads of {m1, m2} are Pa. Payloads of {m3, m4}, {m3, m6} and {m4, m6} are Pc. Note that while a payload of the communication message m5 is Pb, a communication message having the same payload as Pb is not acquired (observed) during the target period, and thus, a set including the communication message m5 is not extracted.

Subsequently, the feature amount extraction unit 14 acquires a transmission period, a margin β and Type corresponding to the target ID from the ID information DB 16 and extracts a feature amount (the following feature amounts a1 and a2) corresponding to the Type (=Type-A) from each target message (each set) on the basis of these kinds of information (S105).

(a1) A feature amount indicating whether two messages have a non-adjacency relationship or an adjacency relationship (“non-adjacency relationship”/“adjacency relationship”)
(a2) A feature amount indicating whether or not an interval of transmission time points of two messages is similar to a transmission period corresponding to the target ID (“similarity”/“dissimilarity”)

Here, whether or not the interval of the transmission time points is similar to the transmission period in the feature amount a2 is defined, for example, as follows.
If the interval of the transmission time points of the two messages is within a range of the transmission period±β (that is, a difference between the interval of the transmission time points and the transmission period (an absolute value of the difference) is equal to or less than a threshold (=β)), the interval is similar to the transmission period. Note that β is preferably less than the transmission period.
If the interval of the transmission time points of the two messages is out of range of the transmission period±β (that is, if a difference between the interval of the transmission time points and the transmission period (an absolute value of the difference) exceeds a threshold (=β)), the interval is not similar to the transmission period.

Note that in the example in FIG. 13, the feature amount a1 extracted for each set of {m1, m2} and {m3, m4} is an “adjacency relationship”, and the feature amount a1 extracted for each set of {m3, m6} and {m4, m6} is a “non-adjacency relationship”. Further, the feature amount a2 extracted for each set of {m1, m2}, {m3, m4} and {m4, m6} is “similarity”, and the feature amount a2 extracted for the set of {m3, m6} is “dissimilarity”.

Subsequently, the rule determination unit 15 determines whether or not there is an attack on the basis of the feature amounts extracted for each target message (S106). In other words, the rule determination unit 15 acquires Type corresponding to the target ID from the ID information DB 16 and acquires the following rules A1 and A2 corresponding to the Type (=Type-A) from the rule DB 17. The rule determination unit 15 determines whether or not there is an attack by determining whether or not a set of the feature amounts a1 and a2 (hereinafter, the set will be referred to as a “feature amount a”) extracted for each target message (each set) corresponds to at least one of the rule A1 or the rule A2.

Rule A1: feature amount a1=“adjacency relationship” and feature amount a2=“dissimilarity”
Rule A2: feature amount a1=“non-adjacency relationship” and feature amount a2=“similarity”

In other words, the rule determination unit 15 determines that an attack is included (in the communication messages acquired by the communication message acquisition unit 11) in the target period in a case where there is a feature amount a that corresponds to at least one of the rules.

In the example in FIG. 13, the feature amount a of {m3, m6} corresponds to the rule A2. Thus, in this case, it is determined that an attack is included (in the communication messages acquired by the communication message acquisition unit 11) in the target period.

On the other hand, in a case where Type corresponding to the target ID is “Type-B” (S103: No), the target message extraction unit 13 extracts the communication messages including payloads identical with payloads of the immediately preceding communication messages as target messages from a plurality of communication messages acquired by the communication message acquisition unit 11 (S107).

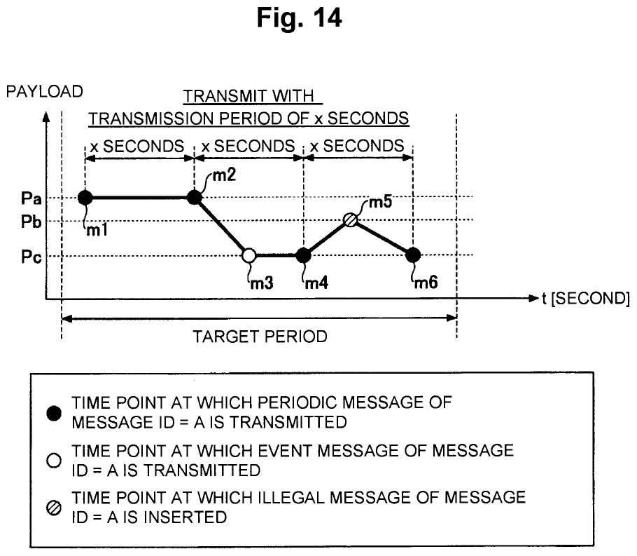

FIG. 14 is a view for supplementing explanation of processing procedure relating to Type-B. FIG. 14 illustrates an example where communication messages of {m1, m2, m3, m4, m5, m6} are acquired in step S101. Meaning of the horizontal axis and the vertical axis in FIG. 14 is the same as the meaning in FIG. 13. Thus, in the example in FIG. 14, each of m2 and m4 is extracted as a target message in step S107. In other words, a payload of the communication message m2 is Pa, and a payload of the immediately preceding communication message m1 is also Pa. Further, a payload of the communication message m4 is Pc, and a payload of the immediately preceding communication message m3 is also Pc.

Subsequently, the feature amount extraction unit 14 acquires a transmission period, a margin β and Type corresponding to the target ID from the ID information DB 16 and extracts a feature amount (the following feature amount b) corresponding to the Type (=Type-B) from the target messages on the basis of these kinds of information (S108).

(b) a feature amount indicating whether or not an interval of transmission time points of the target messages is similar to the transmission period (“similarity”/“dissimilarity”)

Note that similarity regarding the feature amount b may be determined in a similar manner to the feature amount a2.

Subsequently, the rule determination unit 15 acquires Type corresponding to the target ID from the ID information DB 16, acquires the following rule B corresponding to the Type (=Type-B) from the rule DB 17 and determines whether or not the feature amount b extracted for each target message (for each set) corresponds to the rule B to thereby determine whether or not there is an attack (S109).

Rule B: feature amount b=“dissimilarity”

In other words, in a case where one of the feature amounts b corresponds to the rule B, the rule determination unit 15 determines that an attack is included (in the communication messages acquired by the communication message acquisition unit 11) in the target period. Note that in a case where only one target message is extracted, the rule determination unit 15 may determine that there is an attack.

Following the processing in step S106 or step S109, the rule determination unit 15 records (transmits) information indicating a determination result (whether or not there is an attack) in step S106 or step S109 in (to) the determination result storage unit 31 (S110). The information may include, for example, a start time point and an end time point of the target period and a determination result as to whether or not there is an attack. Further, in a case where it is determined that there is an attack (in a case where an attack is detected), a rule that detects the attack may be included in the information.

As described above, according to the first embodiment, it becomes possible to distinguish an insertion attack from normal event transmission occurring at a message having a periodic+event type CAN-ID as well as a message having a periodic CAN-ID. As a result, it is possible to lower a possibility that a normal event message is erroneously detected as an attack, so that it is possible to increase a possibility of detecting an insertion attack. In other words, it is possible to improve detection accuracy of an attack on a network within equipment.

Note that while in the present embodiment, description has been described assuming control communication (CAN communication) of an automobile, the present embodiment is a technique of detecting an insertion attack of an illegal message, which can be applied to other types of communication protocol and network communication within IoT equipment having the following communication characteristics.

A second embodiment will be described next. Points different from the first embodiment will be described in the second embodiment. Points that are not particularly described in the second embodiment may be similar to the first embodiment.

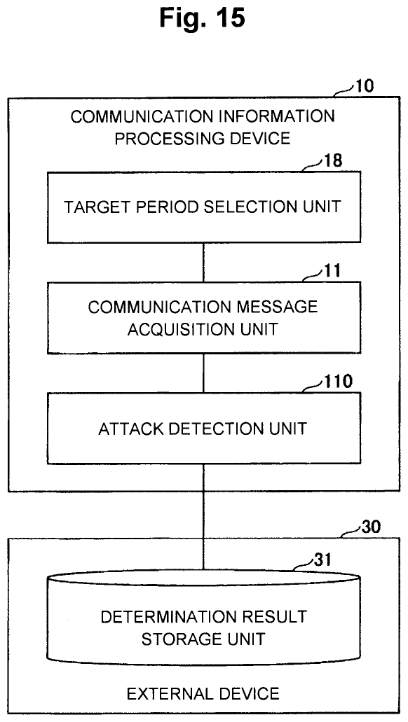

FIG. 15 is a view illustrating a functional configuration example of the communication system 1 in the second embodiment. In FIG. 15, the same reference numerals will be assigned to portions that are the same as the portions in FIG. 11, and description thereof will be omitted.

In FIG. 15, the communication information processing device 10 further includes a target period selection unit 18. The target period selection unit 18 selects a target period (a period during which the communication message acquisition unit 11 monitors (acquires) communication messages). For example, the target period selection unit 18 may select a period that satisfies some kinds of criteria or a period during which an abnormality is detected by other abnormality detectors as the target period. Examples of the period that satisfies some kinds of criteria can include a period before and after a timing at which a payload changes, a period before and after a timing at which a communication message for which a transmission interval is shorter than the transmission period is observed, or the like, for the communication messages including the target IDs.

A third embodiment will be described next. In the third embodiment, points different from the first or the second embodiment will be described. Points that are not particularly described in the third embodiment may be similar to the first or the second embodiment.

FIG. 15 is a view illustrating a functional configuration example of the communication system 1 in the third embodiment. In FIG. 15, the same reference numerals will be assigned to portions that are the same as the portions in FIG. 11, and description thereof will be omitted.

FIG. 15 illustrates a configuration where the external device 30 includes an attack detection unit 110. In this case, the communication message acquisition unit 11 transmits a “payload” and a “transmission time point” of the acquired each communication message to the external device 30. When the attack detection unit 110 of the external device 30 receives these kinds of information, the attack detection unit 110 executes processing procedure in step S102 and subsequent steps in FIG. 12.

In this manner, whether or not there is an attack may be determined (an attack may be detected) using a computer outside the equipment d1.

Note that in the third embodiment, the communication information processing device 10 does not have to include the target period selection unit 18.

Note that the above-described embodiments may be implemented while the periodic CAN-ID is set as a monitoring target by combining the embodiments with the existing abnormality detection technique that is targeted at the periodic CAN-ID.

Note that in the above-described embodiments, the communication information processing device 10 or the external device 30 is an example of the attack detection apparatus. The target message extraction unit 13 is an example of the extraction unit. The rule determination unit 15 is an example of the determination unit.

While the embodiments of the present invention have been described above, the present invention is not limited to such specific embodiments and can be modified and changed in various manners within the scope of the gist of the present invention recited in the claims.

### REFERENCE SIGNS LIST

1 Communication system

10 Communication information processing device

11 Communication message acquisition unit

12 Type determination unit

13 Target message extraction unit

14 Feature amount extraction unit

15 Rule determination unit

16 ID information DB

17 Rule DB

18 Target period selection unit

20 ECU

30 External device

31 Determination result storage unit

101 Auxiliary storage device

102 Memory device

103 CPU

104 Interface device

110 Attack detection unit

B Bus

d1 Equipment

N1 External network

N2 CAN bus

1. An attack detection apparatus that detects an attack on a network within equipment, the attack detection apparatus comprising:
a processor; and
a memory storing program instructions that cause the processor to:
extract a set of two messages having the same payload from a plurality of messages transmitted in a certain period among messages periodically transmitted or messages transmitted asynchronously with the messages in the network; and
determine whether or not the attack is made on a basis of whether or not another message is transmitted between transmissions of the two messages of the set and an interval of transmission of the two messages.

2. The attack detection apparatus according to claim 1,
wherein the processor determines that the attack is made in a case where another message is not transmitted between transmissions of the two messages and a difference between the interval of transmission of the two messages and a transmission period of the periodically transmitted messages exceeds a threshold.

3. The attack detection apparatus according to claim 1,
wherein the processor determines that the attack is made in a case where another message is transmitted between transmissions of the two messages and a difference between the interval of transmission of the two messages and a transmission period of the periodically transmitted messages is equal to or less than a threshold.

4. An attack detection apparatus that detects an attack on a network within equipment, the attack detection apparatus comprising:
a processor; and
a memory storing program instructions that cause the processor to:
extract messages having payloads that are the same as payloads of immediately preceding messages from a plurality of messages transmitted in a certain period among messages periodically transmitted or messages transmitted asynchronously with the messages in the network; and
determine that the attack is made in a case where a difference between an interval of transmission of the extracted messages and a transmission period of the periodically transmitted messages exceeds a threshold.

5. An attack detection method for detecting an attack on a network within equipment, to be executed by a computer, the attack detection method comprising:
extracting a set of two messages having the same payload from a plurality of messages transmitted in a certain period among messages periodically transmitted or messages transmitted asynchronously with the messages in the network; and
determining that the attack is made on a basis of whether or not another message is transmitted between transmissions of the two messages of the set and an interval of transmission of the two messages.

6. (canceled)

7. A non-transitory computer-readable storage medium that stores therein a program for causing a computer to function as the attack detection apparatus according to claim 1.
